(19) United States
(12) Patent Application Publication
(10) Pub. No.: US 2014/0320537 A1
(43) Pub. Date: Oct. 30, 2014

(54) METHOD, DEVICE AND STORAGE MEDIUM FOR CONTROLLING ELECTRONIC MAP

(71) Applicant: TENCENT TECHNOLOGY (SHENZHEN) COMPANY LIMITED, Shenzhen City (CN)

(72) Inventors: YING-FENG ZHANG, Shenzhen City (CN); MU WANG, Shenzhen City (CN); YING-DING HE, Shenzhen City (CN)

(21) Appl. No.: 14/324,076

(22) Filed: Jul. 3, 2014

Related U.S. Application Data
(63) Continuation of application No. PCT/CN2014/070381, filed on Jan. 9, 2014.

(30) Foreign Application Priority Data
Feb. 7, 2013 (CN) 201310049176.1

(51) Int. Cl. G06T 3/60

(52) U.S. Cl. CPC G06T 3/60
USPC 345/659

(57) ABSTRACT

The present disclosure relates to a method, a device and a storage medium for controlling an electronic map. The method includes: detecting a first user operation, configured for setting a viewing angle of the electronic map; in response to the first user operation, setting the viewing angle of the electronic map; and if no first user operation being detected within a predetermined length of time, setting the viewing angle of the electronic map according a posture of the electronic apparatus detected at current time.

### CROSS-REFERENCE

This application is a U.S. continuation application under 35 U.S.C. §111(a) claiming priority under 35 U.S.C. §§120 and 365(c) to International Application No. PCT/CN2014/070381 filed Jan. 9, 2014, which claims the priority benefit of Chinese Patent Application No. 201310049176.1, filed on Feb. 7, 2013, the contents of which are incorporated by reference herein in their entirety for all intended purposes.

### FIELD OF THE INVENTION

The present disclosure relates to computer technology, particularly relates to a method, a device and a storage medium for controlling an electronic map.

### BACKGROUND OF THE INVENTION

Electronic maps with Street View let users explore places around the world through 360-degree, panoramic, and street-level imagery. Because the Street View is usually a panorama of real scene in the physical world, compared to traditional two-dimensional electronic map only indicating roads, the electronic maps with Street View are more intuitively to users. Meanwhile, because processing and operating of Street View relates to multiple angles, compared to traditional two-dimensional electronic map, the control of the electronic maps with Street View is more complex than the control of the two-dimensional electronic map.

For example, in some electronic maps with Street View, when users want to browse a 360-degree street view, at least 10 times of screen dragging are required, so the control efficiency is low, seriously affect the convenience of the relevant function.

### SUMMARY OF THE INVENTION

The present disclosure is to provide a method, a device and a storage medium for controlling an electronic map in an electronic apparatus to solve the problem mentioned above.

Technical solutions provided by embodiments of the present disclosure include:

A method for controlling an electronic map includes: detecting a first user operation, configured for setting a viewing angle of the electronic map; in response to the first user operation, setting the viewing angle of the electronic map; and if no first user operation being detected within a predetermined length of time, setting the viewing angle of the electronic map according a posture of the electronic apparatus detected at current time.

A device for controlling an electronic map, the device comprises at least a processor operating in conjunction with a memory and a plurality of modules, the plurality of modules include: a detecting module, configured to detect a first user operation for setting a viewing angle of the electronic map; a first setting module, configured to set the viewing angle of the electronic map in response to the first user operation; and a second setting module, configured to set the viewing angle of the electronic map according a posture of the electronic apparatus detected at current time, if no first user operation being detected within a predetermined length of time.

A computer-readable storage medium storing instructions for controlling an electronic map, the instructions includes: detecting a first user operation, configured for setting a viewing angle of the electronic map; in response to the first user operation, setting the viewing angle of the electronic map; and if no first user operation being detected within a predetermined length of time, setting the viewing angle of the electronic map according a posture of the electronic apparatus detected at current time.

In accordance with the embodiments, the electronic apparatus may set the viewing angle of the electronic map in response to the first user operation. The electronic apparatus also may set the viewing angle of the electronic map according a posture of the electronic apparatus detected at current time, if no first user operation is detected within a predetermined length of time. Therefore, using efficiency of the electronic map is significantly enhanced and the user operation time is also reduced.

Other features and advantages of the present disclosure will immediately be recognized by persons of ordinary skill in the art with reference to the attached drawings and detailed description of exemplary embodiments as given below.

### BRIEF DESCRIPTION OF THE DRAWINGS

FIG. 1 is a block diagram of an example of electronic apparatus.

FIG. 2 is a flow chart of a method for controlling an electronic map provided by one embodiment of the present disclosure.

FIG. 3 is a flow chart of a method for controlling an electronic map provided by another embodiment of the present disclosure.

FIG. 4 is an illustration of setting the viewing angle according to a rotation angle of the electronic apparatus.

FIG. 5 is a flow chart of a method for controlling an electronic map provided by yet another embodiment of the present disclosure.

FIG. 6 is a flow chart of a method for controlling an electronic map provided by still another embodiment of the present disclosure.

FIG. 7 illustrates an electronic apparatus vertical gripped by the user.

FIG. 8 is an illustration of rotating the viewing angle of the electronic apparatus.

FIG. 9 is an illustration of the viewing angle in the method in FIG. 6.

FIG. 10 is a block diagram of a device for controlling an electronic map according to one embodiment of the present disclosure.

FIG. 11 is a block diagram of a device for controlling an electronic map according to another embodiment of the present disclosure.

### DETAILED DESCRIPTION OF PREFERRED EMBODIMENTS

Various embodiments of the disclosure are discussed in detail below. While specific implementations are discussed, it should be understood that this is done for illustration purposes only. A person skilled in the art will recognize that other components and configurations may be used without parting from the spirit and scope of the disclosure.

The method for controlling an electronic may be applied in an electronic apparatus. The electronic apparatus in the present disclosure, such as desktop computers, notebook computers, smart phones, personal digital assistants, tablet PCs, etc., may install/run one or more smart operating system inside.

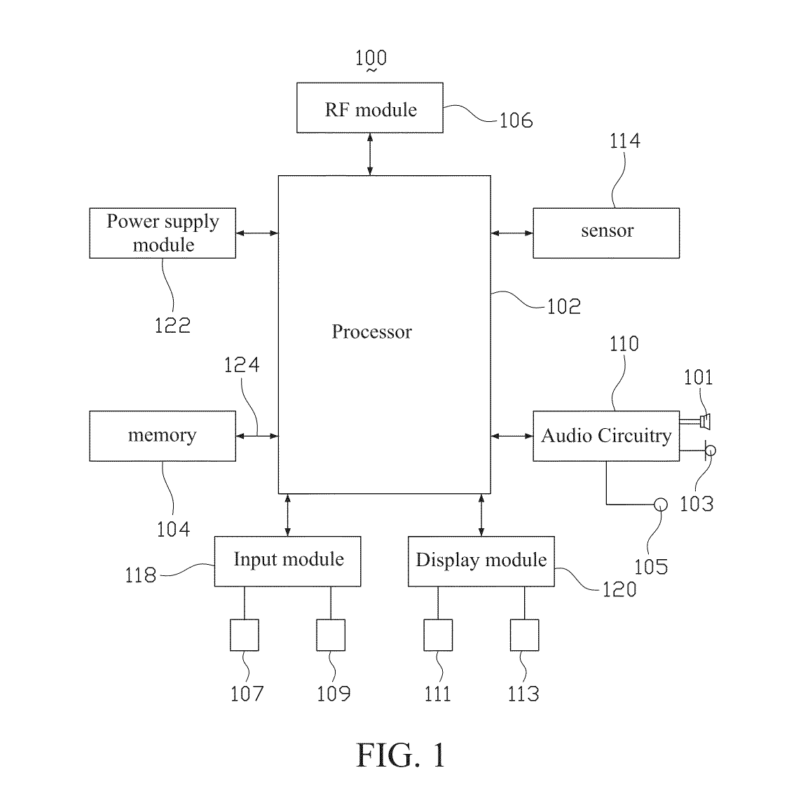

FIG. 1 illustrates an electronic apparatus example in the present disclosure. Referring to FIG. 1, the electronic apparatus 100 includes one or more (only one in FIG. 1) processors 102, a memory 104, a Radio Frequency (RF) module 106, an Audio circuitry 110, a sensor 114, an input module 118, a display module 120, and a power supply module 122. A person skilled in the art will understand that the structure in FIG. 1 is shown for illustration purposes only, not limitations of the electronic apparatus 100. For example, the electronic apparatus 100 may also include more or less parts than FIG. 1 shows, or different configuration.

It can be understood by those skilled in the art that besides the processor 102, all other components are belong to peripheral. The processor 102 and the peripherals are coupled by many peripheral interfaces 124. Peripheral interfaces 124 may be implemented based on the following standards: Universal Asynchronous Receiver/Transmitter (UART), General Purpose Input Output (GPIO), Serial Peripheral Interface (SPI), Inter-Integrated Circuit (I2C), but not limited to the above standards. In some examples, the peripheral interfaces 124 may only include the bus; while in other examples, the peripheral interfaces 124 may also include other components, one or more controllers, for example, which may be a display controller for connecting a liquid crystal display panel or a storage controller for connecting storage. In addition, these controllers may also be separated from the peripheral interface 124, and integrated inside the processor 102 or the corresponding peripheral.

The memory 104 may be used to store software programs and modules, such as the program instructions/modules corresponding to the method and device of controlling an electronic map in the various embodiments of the present disclosure. The processor 102 performs a variety of functions and data processing by running the software program and the module stored in the memory 104, which implements the above method of processing virus in the electronic apparatus in the various embodiments of the present disclosure. Memory 104 may include high-speed random access memory and nonvolatile memory, such as one or more magnetic storage devices, flash memory, or other non-volatile solid-state memory. In some examples, the memory 104 may further include a remote configured memory compared to the processor 102, which may be connected to the electronic apparatus 100 via the network. The network instances include but not limited to, the Internet, intranets, local area network, mobile communication network, and their combinations.

The RF module 106 is used for receiving and transmitting electromagnetic waves, implementing the conversion between electromagnetic waves and electronic signals, and communicating with the communication network or other devices. The RF module 106 may include a variety of existing circuit elements, which perform functions, such as antennas, RF transceivers, digital signal processors, encryption/decryption chips, the subscriber identity module (SIM) card, memory, etc. The RF module 106 can communicate with a variety of networks such as the Internet, intranets, wireless network and communicate to other devices via wireless network. The above wireless network may include a cellular telephone network, wireless local area network (LAN) or metropolitan area network (MAN). The above wireless network can use a variety of communications standards, protocols and technologies, including but not limited to Global System for Mobile Communication (GSM), Enhanced Data GSM Environment (EDGE), wideband code division multiple access (W-CDMA), Code division access (CDMA), time division multiple access (TDMA), Wireless, Fidelity (WiFi) (such as the American Institute of Electrical and Electronics Engineers Association standards IEEE 802.11a, IEEE 802.11b, IEEE802.11g , and/or IEEE 802.11n), Voice over internet protocol (VoIP), Worldwide Interoperability for Microwave Access (Wi-Max), other protocols used for mail, instant messaging and short message, as well as any other suitable communication protocol, even including the protocols which are not yet been developed currently.

The Audio circuitry 110, the speaker 101, the audio jack 103, the microphone 105 together provide the audio interface between the user and the electronic device 100. Specifically, the audio circuit 110 receives audio data from the processor 102, converts the audio data into an electrical signal, and transmits the signal to the speaker 101. The speaker 101 converts the electrical signals to sound waves which can be heard by human ears. The audio circuitry 110 also receives electronic signals from the microphone, converts electronic signals to audio data, and transmits the audio data to the processor 102 for further processing. The audio data may also be acquired from the memory 104 or the RF module 106, the transmission module 108. In addition, the audio data may also be stored in the memory 104 or transmitted by the RF module 106 and the transmission module 108.

Examples of sensor 114 include but not limited to: an optical sensor, an operating sensor, and other sensors. Specifically, the optical sensor may include an ambient light sensor and a proximity sensor. The ambient light sensor may sense ambient light and shade, and then some modules executed by the processor 102 may use the output of the ambient light sensor to automatically adjust the display output. The proximity sensor may turn off the display output when detect the electronic device 100 near the ear. As a kind of motion sensor, gravity sensor may detect the value of acceleration in each direction, and the value and direction of gravity when the gravity sensor keeps still, which can be used for applications to identify the phone posture (such as horizontal and vertical screen switching, related games, magnetometer posture calibration), and for vibration recognition related functions (such as pedometer, percussion), etc.. The electronic device 100 may also include a gyroscope, a barometer, a hygrometer, a thermometer, and other sensors, which is not shown for the purpose of brevity.

The input unit 118 may be configured to receive the input character information, and to generate input by keyboard, mouse, joystick, optical or trackball signal related to user settings and function control. Specifically, the input unit 130 may include button 107 and touch surface 109. The buttons 107 for example, may include character buttons for inputting characters, and control buttons for triggering control function. The instances of the control buttons may include a “back to the main screen” button, a power on/off button, an imaging apparatus button and so on. The touch surface 109 may collect user operation on or near it (for example, a user uses a finger, a stylus, and any other suitable object or attachment to operate on or near the touch surface 109), and drive the corresponding connecting device according to pre-defined program. Optionally, the touch surface 109 may include a touch detection device and a touch controller. The touch detection device detects users' touch position and a signal produced by the touch operation, and passes the signal to the touch controller. The touch controller receives touch information from the touch detection device, converts the touch information into contact coordinates, sends the contact coordinates to the processor 102, and receives and executes commands sent from the processor 102. In addition, the touch surface 109 may be implemented in resistive, capacitive, infrared, surface acoustic wave and other forms. Besides the touch surface 109, the input unit 118 may also include other input devices. The preceding other input devices include but not limited to, one or more physical keyboards, trackballs, mouse, joysticks, etc.

The display module 120 is configured to display the information input by users, the information provided to users, and a variety of graphical user interfaces of the electronic device 100. The graphical user interfaces may consist of graphics, text, icons, video, and any combination of them. In one example, the display module 120 includes a display panel 111. The display panel 111 may for example be a Liquid Crystal Display (LCD) panel, an Organic Light-Emitting Diode Display (OLED) panel, an Electro-Phoretic Display (EPD) panel and so on. Furthermore, the touch surface 109 may be on top of the display panel 111 as a whole. In other embodiments, the display module 120 may also include other types of display devices, such as a projection display device 113. Compared with the general display panel, the projection display device 113 needs to include a plurality of components for projection, such as a lens group.

The power supply module 122 is used to provide power for the processor 102 and other components. Specifically, the power supply module 122 may include a power management system, one or more power supplies (such as a battery or AC), a charging circuit, a power failure detection circuit, an inverter, a power status indicator, and any other components related to electricity generation, management and distribution within the electronic device 100.

The electronic map in the present disclosure, for example, refers to a map having a control requirements in three-dimensional viewing angle, such as the electronic map with panoramic images, and the electronic maps modeled according to the three-dimensional spatial.

The control of the electronic map can be triggered by a variety of user operations, specific examples of user operations include, but are not limited to: dragging or swipe gestures, vibration, shaking or rotating the electronic apparatus, click on the interface buttons, menus, or icons, and so on. The present disclosure, the user operation for the electronic map is divided into a first user operation and a second user operation. The second user operation is triggered by detecting the rotation angle of the electronic apparatus within a length of time. The first user operation is triggered by all other user actions.

### FIRST EMBODIMENT

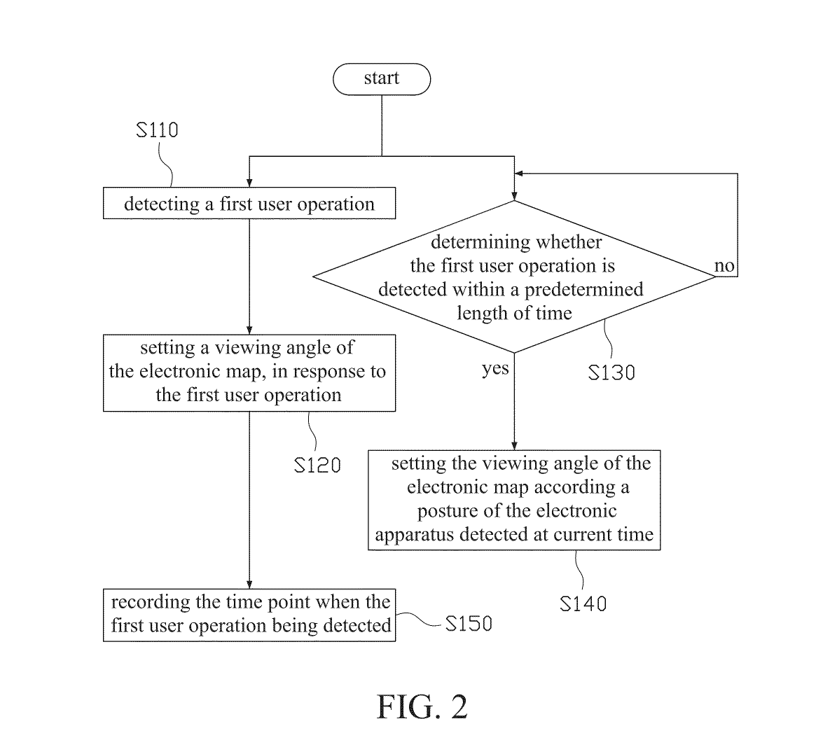

Referring to FIG. 2, which is a flow chart of a method for controlling an electronic map provided by a first embodiment of the present disclosure. The method includes the following steps.

In Step 110, the electronic apparatus detects a first user operation.

The detecting of the first user operation may be achieved by detecting events of interface object. The events include clicking, sliding, dragging, or double-clicking the object on the interface. In other words, when these events are triggered, the first user operation is detected. Of course, as mentioned above, the first user operation is not limited to the operation to the objects on the interface, but also can be implemented through various sensors such as a microphone, the vibration sensor or the like.

In Step 120, the electronic apparatus sets a viewing angle of the electronic map, in response to the first user operation.

In general, the value of the viewing angle of the electronic map can be directly obtained from the first user operation. For example, if a screen dragging of the electronic map is detected, the rotation angle is calculated according to drag distance. The viewing angle of the electronic map is rotated with the rotation angle in the drag direction of the screen dragging. As another example, if a rotation left button is pressed by users, the viewing angle of the electronic map is rotated with a predetermined angle associated with the rotation left button.

In Step 130, the electronic apparatus determines whether the first user operation is detected within a predetermined length of time. If yes, Step 140 is performed.

Step 130 and Step 140 may be performed respectively. The determining in the Step 130 may be dependent on the result of the Step 110. Specifically, once detecting the first user operation, the Step 150 will be performed. In Step 150, the electronic apparatus records the time point when the first user operation is detected. In the initial state, the operation start time of the method in the exemplary embodiment may be considered as the time point when the first user operation is detected. Periodically calculating an interval between the current time and the operation start time, and if the interval exceeds a predetermined length of time (e.g., 1 second), Step 140 will be performed. The periodically calculating can be implemented by a timer, and the specific interval can be set according actual needs.

In Step 140, the electronic apparatus sets the viewing angle of the electronic map according a posture of the electronic apparatus detected at current time.

The posture of the electronic apparatus refers to the posture of the electronic apparatus in a three-dimensional space, which generally can be described by a pitch angle, a yaw angle, and a roll angle.

In accordance with the embodiment, the electronic apparatus may set the viewing angle of the electronic map in response to the first user operation. The electronic apparatus also may set the viewing angle of the electronic map according a posture of the electronic apparatus detected at current time, if no first user operation is detected within a predetermined length of time. Therefore, using efficiency of the electronic map is significantly enhanced and the user operation time is also reduced.

### SECOND EMBODIMENT

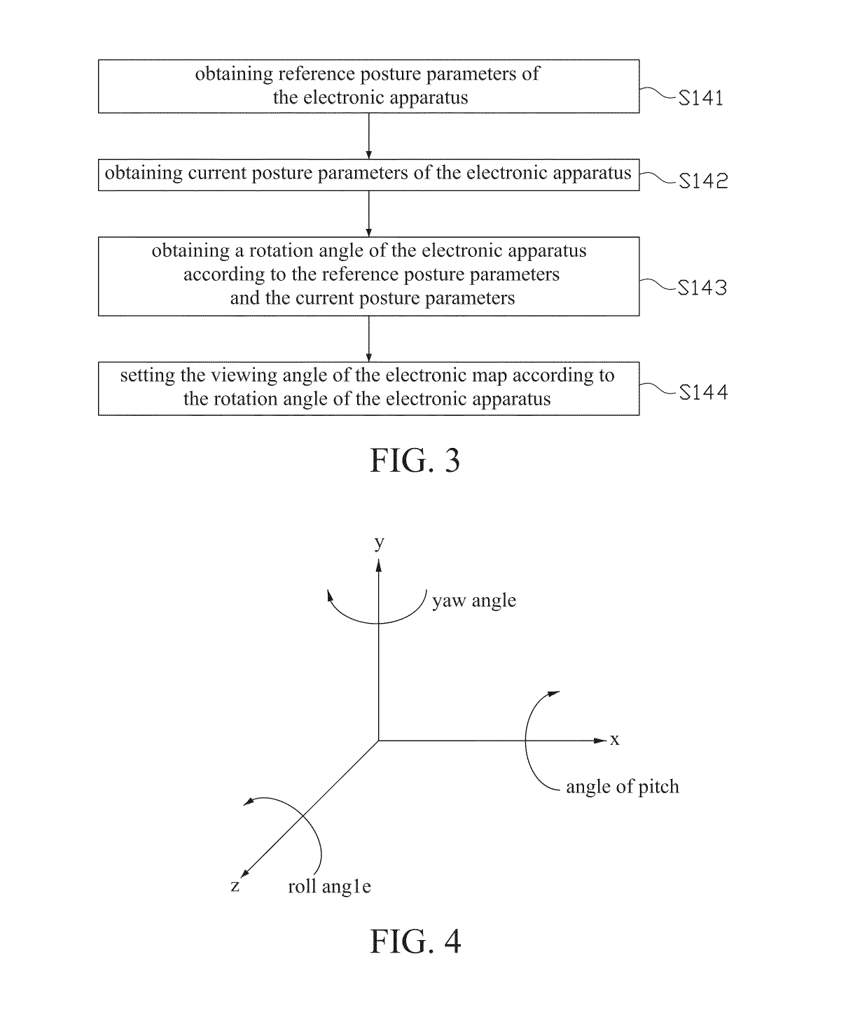

Referring to FIG. 3, which is a flow chart of a method for controlling an electronic map provided by a second embodiment of the present disclosure. The method in the second embodiment is similar with the method in the first embodiment. The difference between the first embodiment and the second embodiment is that, the Step 140 in the method of the second embodiment includes the following steps:

In Step 141, the electronic apparatus obtains reference posture parameters of itself.

It can be understood that, to get the reference posture parameters of electronic terminal, posture detection function of the electronic apparatus (related sensors such as gyroscopes) should be opened. If before Step 141, the posture detection function is not open, users need to open the relevant posture detection function, and then get posture parameters of electronic terminal, which was used as reference posture parameters of the electronic apparatus.

In the U.S. Apple's iOS operating system, for example, a space posture matrix can be obtained through CMAttitude class, and then posture angles, such as the pitch angle, the yaw angle and the roll angle can be obtained through the space posture matrix.

In Step 142, the electronic apparatus obtains current posture parameters of itself.

Every once in a while, current posture parameters of the electronic apparatus can be reacquired, similar with Step 141,

In Step 143, the electronic apparatus obtains a rotation angle of itself according to the reference posture parameters and the current posture parameters.

The rotation angle of the electronic apparatus can be obtained by calculating the difference between the current posture angle obtained in Step 142 and the posture angle obtained in Step 141, as mentioned above in each direction.

It can be understood that, there is a mapping relationship between the pitch angle, the yaw angle, and the roll angle of the electronic apparatus and the coordinate system thereof. As shown in FIG. 4, for example, the pitch angle is associated with the x-axis, the yaw angle is associated with y axis, and the roll angle is associated with z-axis. Furthermore, due to the electronic apparatuses have horizontal and vertical screen adjustment function requiring at least one rotation angle. In general, the roll angle is required in the horizontal and vertical screen adjustment. In the present disclosure, if using the roll angle and rotating about the z-axis, users will feel the electronic apparatus is too sensitive, but not convenient to browse. If the z-axis is not used, rotating about x, y, because the order of the rotation angle, the obtained yaw angle and pitch angle are not real value of the yaw angle and pitch angle. To solve this problem, the rotation angle of z, x, y can be adjusted to the rotation angle of x, y, z by the three-dimensional converting algorithm. After adjustment, the rotation angle associated with z-axis is the last one, so the obtained yaw angle and pitch angle are real value of the yaw angle and pitch angle.

In Step 144, the electronic apparatus sets the viewing angle of the electronic map according to the rotation angle thereof.

Due to various reasons (e.g., hand instability), the electronic apparatus may be shake in a relatively small amplitude. In this condition, the rotation angle obtained in Step 144 is a smaller value, and frequently adjusting the viewing angle of the electronic map will affect the normal use of the electronic apparatus. Thus, in Step 144, if the rotation angle of the electronic apparatus is smaller than a predetermined value, such as 10 degrees, the viewing angle is kept unchanged.

It can be understood that, the above-mentioned Step 141 may be performed only once, and then Step 142 to Step 144 are repeated. So long as the user changes the position of the electronic apparatus, the viewing angle of the electronic map can be adjusted.

Further, after Step 110, if the first user operation is detected, the posture detection function of the electronic apparatus may be closed to avoid interference.

### THIRD EMBODIMENT

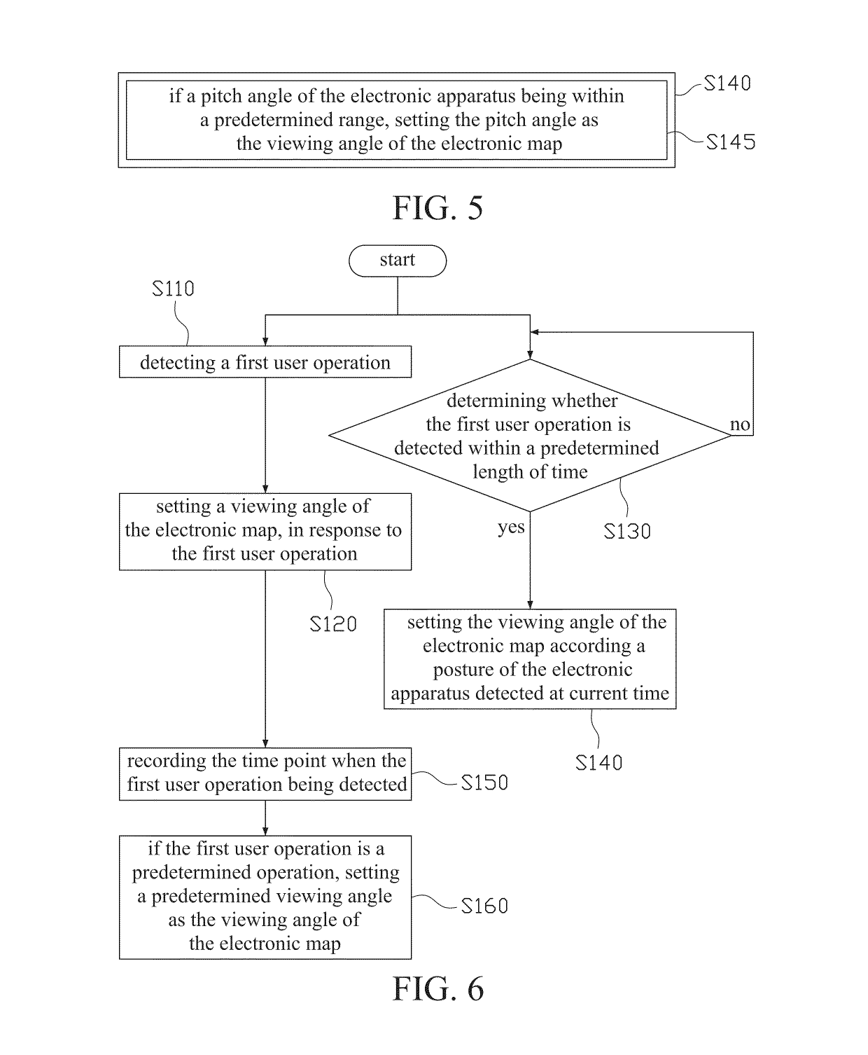

Referring to FIG. 5, which is a flow chart of a method for controlling an electronic map provided by a third embodiment of the present disclosure. The method in the third embodiment is similar with the method in the first embodiment. The difference between the first embodiment and the third embodiment is that, the Step 140 in the method of the third embodiment includes the following steps:

In Step 145, if a pitch angle of the electronic apparatus being within a predetermined range, the electronic apparatus sets the pitch angle as the viewing angle of the electronic map.

The predetermined range, for example, may be a range from about 80 degrees to about 100 degrees.

It can be understood that, in normal use, the pitch angle of the electronic apparatus is about 45 degrees. At this time, a horizontal viewing angle will be displayed in accordance with using habit. In this context, if the user moves the electronic apparatus to a direction, wherein the longitudinal axis of the electronic apparatus is in a vertical direction, according to the viewing angle setting process of the aforementioned embodiments, the electronic map will show the sky. In this condition, the electronic map displays less useful information. If setting the pitch angle as the viewing angle of the electronic map, the pitch angle of the electronic map will be exactly the same with the pitch angle of the electronic apparatus, so that the electronic map can display more useful information.

### FOURTH EMBODIMENT

Referring to FIG. 6, which is a flow chart of a method for controlling an electronic map provided by a fourth embodiment of the present disclosure. The method in the fourth embodiment is similar with the method in the first embodiment. The difference between the first embodiment and the fourth embodiment is that, after the Step 150, the method of the fourth embodiment includes the following steps:

In Step 160, if the first user operation is a predetermined operation, the electronic apparatus sets a predetermined viewing angle as the viewing angle of the electronic map.

The predetermined viewing angle may include a default viewing angle of the electronic map, such as a 0 degree pitch angle, a 0 degree yaw angle, and a 0 degree roll angle.

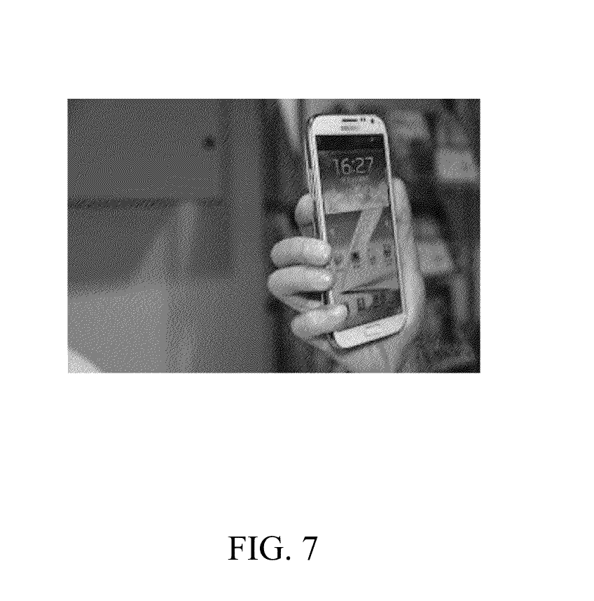

The predetermined user operation, for example, may include a predetermined voice order or a vibration within a predetermined frequency range and all the like. The predetermined user operation may also be a rotation of the electronic apparatus to a specific angle by users. Referring to FIG. 7, which illustrates an electronic apparatus vertical gripped by the user (not shown). In FIG. 7, the user moves the electronic apparatus to a direction, wherein the longitudinal axis of the electronic apparatus is in a vertical direction.

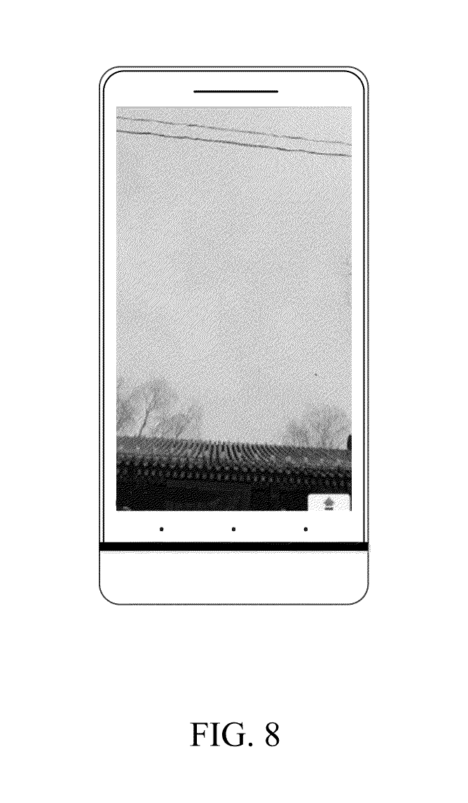

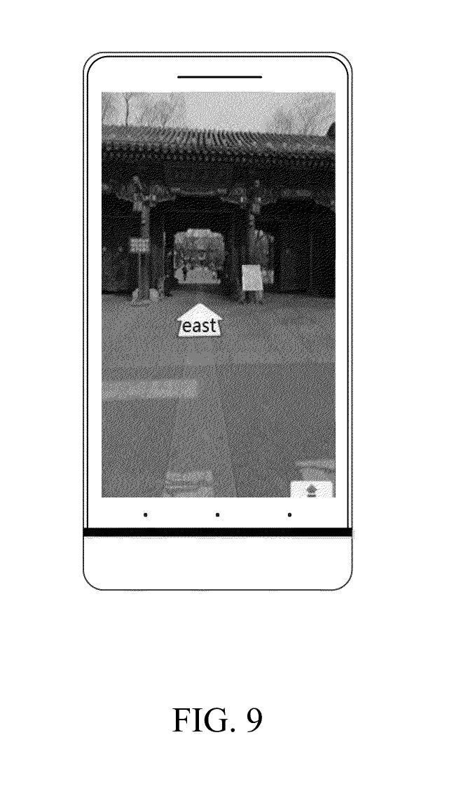

As described in the third embodiment, when the pitch angle of the electronic apparatus is about 45 degrees, the viewing angle of the electronic map is a horizontal viewing angle. According to the real-time adjustment of the electronic map according to the rotation angle of the electronic apparatus, in the foregoing embodiment, the viewing angle of the electronic map should be the viewing angle shown in FIG. 8. In FIG. 8 most of the electronic map will show the sky, in this state, the electronic map will show less useful information. At this time, predetermined viewing angle (i.e., default viewing angle mentioned above) can be set as the viewing angle of the electronic map, as shown in FIG. 9.

It can be understood that, according to the above steps, the viewing angle can be easily restored to the default viewing angle, so that the efficiency of the map control is improved and the operating time of users are reduced.

### FIFTH EMBODIMENT

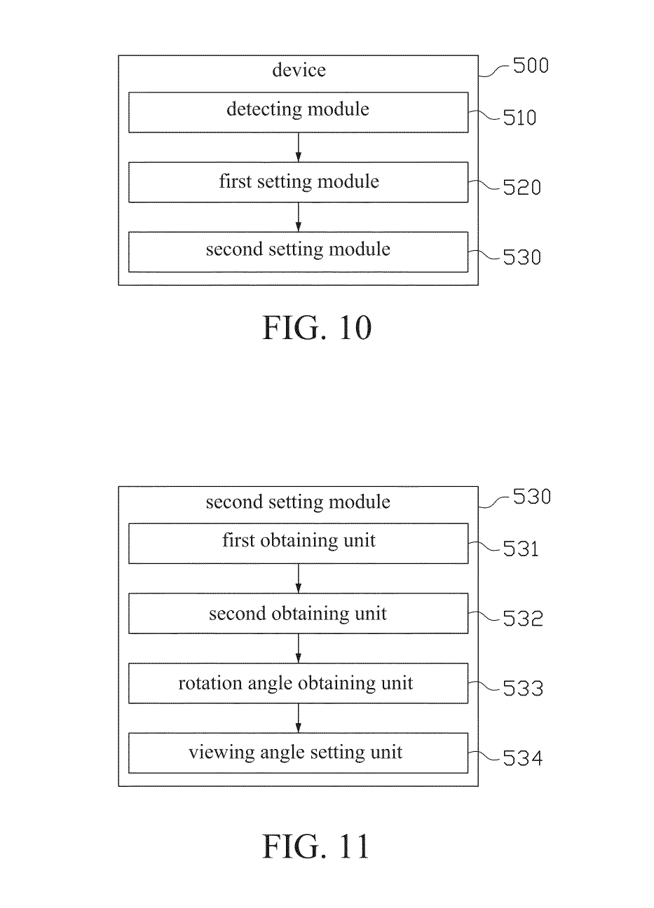

FIG. 10 is a block diagram of a device for controlling an electronic map according to a fifth embodiment of the present disclosure. Referring to FIG. 10, the device 500 may include a detecting module 510, a first setting module 520 and a second setting module 530.

The detecting module 510 is configured to detect a first user operation for setting a viewing angle of the electronic map.

The detecting module 510 is further configured to record the time point when the first user operation is detected.

The first setting module 520 is configured to set the viewing angle of the electronic map in response to the first user operation.

The second setting module 530 is configured to set the viewing angle of the electronic map according a posture of the electronic apparatus detected at current time, if no first user operation being detected within a predetermined length of time.

In accordance with the embodiment, the electronic apparatus may set the viewing angle of the electronic map in response to the first user operation. The electronic apparatus also may set the viewing angle of the electronic map according a posture of the electronic apparatus detected at current time, if no first user operation is detected within a predetermined length of time. Therefore, using efficiency of the electronic map is significantly enhanced and the user operation time is also reduced.

### SIXTH EMBODIMENT

Referring to FIG. 11, which is a block diagram of a device for controlling an electronic map according to a sixth embodiment of the present disclosure. The device in the sixth embodiment is similar with the device in the fifth embodiment. The difference between the fifth embodiment and the sixth embodiment is that, the second setting module 530 in sixth embodiment includes:

a first obtaining unit 531, configured to obtain reference posture parameters of the electronic apparatus;

a second obtaining unit 532, configured to obtain current posture parameters of the electronic apparatus;

rotation angle obtaining unit 533, configured to obtain a rotation angle of the electronic apparatus according the reference posture parameters and the current posture parameters; and

a viewing angle setting unit 534, configured to set the viewing angle of the electronic map according to the rotation angle of the electronic apparatus.

In addition, the second setting module 530 may further include an opening unit, configured to open posture detection function of the electronic apparatus; and a closing unit, configured to close the posture detection function of the electronic apparatus, if the first user operation being detected.

### SEVENTH EMBODIMENT

The seventh embodiment also provides a device for controlling an electronic map. The device in the seventh embodiment is similar with the device in the fifth embodiment. The difference between the fifth embodiment and the seventh embodiment is that, the second setting module 530 in the seventh embodiment is further configured to set the pitch angle as the viewing angle of the electronic map, if a pitch angle of the electronic apparatus is within a predetermined range. The predetermined range is from 80 degrees to 100 degrees, for example.

If setting the pitch angle as the viewing angle of the electronic map, the pitch angle of the electronic map will be exactly the same with the pitch angle of the electronic apparatus, so that the electronic map can display more useful information.

### EIGHTH EMBODIMENT

The eighth embodiment also provides a device for controlling an electronic map. The device in the eighth embodiment is similar with the device in the fifth embodiment. The difference between the fifth embodiment and the eighth embodiment is that, the first setting module 510 in eighth embodiment is further configured to set the viewing angle of the electronic map as a predetermined viewing angle, if the first user operation being a predetermined operation.

The predetermined viewing angle may include a default viewing angle of the electronic map, such as a 0 degree pitch angle, a 0 degree yaw angle, and a 0 degree roll angle.

The predetermined user operation, for example, may include a predetermined voice order or a vibration within a predetermined frequency range and all the like.

It can be understood that, according to the above steps, the viewing angle can be easily restored to the default viewing angle, so that the efficiency of the map control is improved and the operating time of users are reduced.

What's more, various devices provided by the embodiments of the disclosure discussed above is done for illustration purposes only, and should not be taken as limitations of the general principles of the device for processing virus in electronic apparatus provided by the embodiment of the disclosure. It will be understood that various combinations and changes in the form and details of the device illustrated may be made by those skilled in the art without departing from the disclosure.

Embodiments within the scope of the present disclosure may also include computer-readable media for carrying or having computer-executable instructions or data structures stored thereon. Such computer-readable media can be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium which can be used to carry or store desired program code means in the form of computer-executable instructions or data structures. When information is transferred or provided over a network or another communications connection (either hardwired, wireless, or combination thereof) to a computer, the computer properly views the connection as a computer-readable medium. A “tangible” computer-readable medium expressly excludes software per se (not stored on a tangible medium) and a wireless, air interface. Thus, any such connection is properly termed a computer-readable medium. Combinations of the above should also be included within the scope of the computer-readable media.

Computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules include routines, programs, objects, components, and data structures, etc. that performs particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps. Program modules may also comprise any tangible computer-readable medium in connection with the various hardware computer components disclosed herein, when operating to perform a particular function based on the instructions of the program contained in the medium.

The above descriptions are only preferred embodiments of the present disclosure, and are not intended to limit the present disclosure. Any amendments, replacement and modification made to the above embodiments under the spirit and principle of the present disclosure should be included in the scope of the present disclosure.

What is claimed is:

1. A method for controlling an electronic map in an electronic apparatus, the method comprising:
detecting a first user operation for setting a viewing angle of the electronic map;
in response to the first user operation, setting the viewing angle of the electronic map; and
if no first user operation being detected within a predetermined length of time, setting the viewing angle of the electronic map according a posture of the electronic apparatus detected at current time.

2. The method as claimed in claim 1, wherein, the step of setting the viewing angle of the electronic map according a posture of the electronic apparatus detected at current time, comprises:
obtaining reference posture parameters of the electronic apparatus;
obtaining current posture parameters of the electronic apparatus;
according to the reference posture parameters and the current posture parameters, obtaining a rotation angle of the electronic apparatus; and
setting the viewing angle of the electronic map according to the rotation angle of the electronic apparatus.

3. The method as claimed in claim 2, further comprising:
before the step of obtaining reference posture parameters of the electronic apparatus, opening posture detection function of the electronic apparatus; and
if the first user operation being detected, closing the posture detection function of the electronic apparatus.

4. The method as claimed in claim 2, wherein, the step of setting the viewing angle of the electronic map according to the rotation angle of the electronic apparatus, comprises:
if the rotation angle of the electronic apparatus being smaller than a predetermined value, keeping the viewing angle unchanged.

5. The method as claimed in claim 1, wherein, the step of setting the viewing angle of the electronic map according a posture of the electronic apparatus detected at current time, comprises:
if a pitch angle of the electronic apparatus being within a predetermined range, setting the pitch angle as the viewing angle of the electronic map.

6. The method as claimed in claim 5, wherein, the predetermined range is from 80 degrees to 100 degrees.

7. The method as claimed in claim 5, wherein, the step of setting the viewing angle of the electronic map in response to the first user operation, comprises:
if the first user operation being a predetermined operation, setting a predetermined viewing angle as the viewing angle of the electronic map.

8. A device for controlling an electronic map, wherein the device comprises at least a processor operating in conjunction with a memory and a plurality of modules, the plurality of modules comprises:
a detecting module, configured to detect a first user operation for setting a viewing angle of the electronic map;
a first setting module, configured to set the viewing angle of the electronic map in response to the first user operation; and
a second setting module, configured to set the viewing angle of the electronic map according a posture of the electronic apparatus detected at current time, if no first user operation being detected within a predetermined length of time.

9. The device as claimed in claim 8, wherein, the second setting module comprises:
a first obtaining unit, configured to obtain reference posture parameters of the electronic apparatus;
a second obtaining unit, configured to obtain current posture parameters of the electronic apparatus;
rotation angle obtaining unit, configured to obtain a rotation angle of the electronic apparatus according the reference posture parameters and the current posture parameters; and
a viewing angle setting unit, configured to set the viewing angle of the electronic map according to the rotation angle of the electronic apparatus.

10. The device as claimed in claim 9, wherein, the second setting module comprises:
an opening unit, configured to open posture detection function of the electronic apparatus; and
a closing unit, configured to close the posture detection function of the electronic apparatus, if the first user operation being detected.

11. The device as claimed in claim 9, wherein, the viewing angle setting unit is further configured to keep the viewing angle unchanged, if the rotation angle of the electronic apparatus being smaller than a predetermined value.

12. The device as claimed in claim 8, wherein, the second setting module is further configured to set the pitch angle as the viewing angle of the electronic map, if a pitch angle of the electronic apparatus being within a predetermined range.

13. The device as claimed in claim 12, wherein, the predetermined range is from 80 degrees to 100 degrees.

14. The device as claimed in claim 8, wherein, the first setting module is further configured to set the viewing angle of the electronic map as a predetermined viewing angle, if the first user operation being a predetermined operation.

15. A non-transitory computer-readable storage medium storing instructions for controlling an electronic map, the instructions comprising:
detecting a first user operation for setting a viewing angle of the electronic map;
in response to the first user operation, setting the viewing angle of the electronic map; and
if no first user operation being detected within a predetermined length of time, setting the viewing angle of the electronic map according a posture of the electronic apparatus detected at current time.

16. The computer-readable storage medium as claimed in claim 15, wherein, the step of setting the viewing angle of the electronic map according a posture of the electronic apparatus detected at current time, comprises:
obtaining reference posture parameters of the electronic apparatus;
obtaining current posture parameters of the electronic apparatus;
according the reference posture parameters and the current posture parameters, obtaining a rotation angle of the electronic apparatus; and
setting the viewing angle of the electronic map according to the rotation angle of the electronic apparatus.

17. The computer-readable storage medium as claimed in claim 16, further comprising:
before the step of obtaining reference posture parameters of the electronic apparatus, opening posture detection function of the electronic apparatus; and
if the first user operation being detected, closing the posture detection function of the electronic apparatus.

18. The computer-readable storage medium as claimed in claim 16, wherein, the step of setting the viewing angle of the electronic map according to the rotation angle of the electronic apparatus, comprises:
if the rotation angle of the electronic apparatus being smaller than a predetermined value, keeping the viewing angle unchanged.

19. The computer-readable storage medium as claimed in claim 15, wherein, the step of setting the viewing angle of the electronic map according a posture of the electronic apparatus detected at current time, comprises:
if a pitch angle of the electronic apparatus being within a predetermined range, setting the pitch angle as the viewing angle of the electronic map.

20. The computer-readable storage medium as claimed in claim 15, wherein, the step of setting the viewing angle of the electronic map in response to the first user operation, comprises:
if the first user operation being a predetermined operation, setting a predetermined viewing angle as the viewing angle of the electronic map.
